(19) United States
(12) Patent Application Publication
(10) Pub. No.: US 2023/0250004 A1
(43) Pub. Date: Aug. 10, 2023

(54) WET AIR OXIDATION SYSTEM WITH SHELL AND TUBE HEAT EXCHANGER

(71) Applicant: Siemens Energy, Inc., Orlando, FL (US)

(72) Inventor: Chad L. Felch, Kronenwetter, WI (US)

(21) Appl. No.: 18/004,678

(22) PCT Filed: Jul. 22, 2021
(86) PCT No.: PCT/US2021/042687

§ 371 Date: Jan. 9, 2023

Related U.S. Application Data
(60) Provisional application No. 63/058,055, filed on Jul. 29, 2020.

(51) Int. Cl. C02F 11/08; C02F 1/72; B01D 53/34; B01J 3/00

(52) U.S. Cl. CPC C02F 11/08; B01D 53/343; B01J 3/008; C02F 1/72; C02F 2101/40

(57) ABSTRACT

A wet air oxidation system includes a reactor including an inlet and an outlet. The reactor is operable to oxidize a portion of a two-phase process fluid and to discharge a hot oxidized fluid from the outlet. A heat exchanger includes a plurality of tubes that extend along a long axis of the heat exchanger and cooperate to define a hot fluid inlet coupled to the outlet to receive the hot oxidized fluid and a hot fluid outlet, a shell that surrounds the plurality of tubes and defines a process fluid inlet arranged to receive the two-phase process fluid, and a process fluid outlet arranged to discharge a preheated two-phase process fluid to the inlet of the reactor, wherein the long axis of the heat exchanger is arranged in a non-horizontal direction.

### BACKGROUND

In some processes, such as Wet Air Oxidation (WAO) a two-phase flow can be employed. In the case of WAO there is typically a liquid and gas phase in the process fluid flow. The gas phase contains oxygen which is then transferred to the liquid phase to perform reactions. The materials of construction of the system often requires that an oxidative environment be kept in the system to form a protective oxide layer (passivation). When reactive compounds such as sulfides in spent caustic are present, they consume the oxygen in the liquid phase quickly and have the potential to create a reducing environment if the oxygen is not replenished through mixing and oxygen transfer between the gas and liquid. This reducing environment, if present can be harmful to some materials used in WAO systems.

### BRIEF SUMMARY

In one arrangement, a wet air oxidation system includes a reactor including an inlet and an outlet. The reactor is operable to oxidize a portion of a two-phase process fluid and to discharge a hot oxidized fluid from the outlet. A heat exchanger includes a plurality of tubes that extend along a long axis of the heat exchanger and cooperate to define a hot fluid inlet coupled to the outlet to receive the hot oxidized fluid and a hot fluid outlet, a shell that surrounds the plurality of tubes and defines a process fluid inlet arranged to receive the two-phase process fluid, and a process fluid outlet arranged to discharge a preheated two-phase process fluid to the inlet of the reactor, wherein the long axis of the heat exchanger is arranged in a non-horizontal direction.

In addition, the arrangement provides a method of operating a wet air oxidation system that includes orienting a long axis of a shell and tube heat exchanger in a non-horizontal direction, directing a cool two-phase process fluid to an inlet of a shell of the shell and tube heat exchanger, and receiving a hot oxidized fluid in a plurality of tubes of the shell and tube heat exchanger. The method also includes heating the two-phase process fluid with the hot oxidized fluid to produce a preheated two-phase process fluid, directing the preheated two-phase process fluid to a reactor and at least partially oxidizing the preheated two-phase process fluid to produce the hot oxidized fluid, and discharging the hot oxidized fluid from the reactor.

In another arrangement, a wet air oxidation system includes a reactor including an inlet and an outlet, the reactor operable to oxidize a portion of a pre-heated two-phase process fluid and to discharge a hot oxidized fluid from the outlet. An air compressor is operable to provide a flow of compressed air to a process fluid to define a two-phase process fluid, and a separator is operable to receive a flow of cooled oxidized fluid and operable to separate the cooled oxidized fluid into an off-gas and a treated effluent. A heat exchanger includes a plurality of tubes that extend in a direction that is parallel to a long axis of the heat exchanger and a shell that surrounds a portion of the tubes, each of the plurality of tubes includes an inlet positioned to receive a portion of the hot oxidized fluid and an outlet arranged to discharge a portion of the cooled oxidized fluid. The shell includes an inlet arranged to receive the two-phase process fluid and an outlet arranged to discharge the pre-heated two-phase process fluid. The heat exchanger is operable to preheat the two-phase process fluid contained within the shell using the hot oxidized fluid entering the plurality of tubes.

### BRIEF DESCRIPTION OF THE DRAWINGS

To easily identify the discussion of any particular element or act, the most significant digit or digits in a reference number refer to the figure number in which that element is first introduced.

FIG. 1 is a schematic illustration of a wet air oxidation system that includes a heat recovery heat exchanger.

FIG. 2 is a schematic illustration of a prior art tube-in-tube heat exchanger currently used as the heat recovery heat exchanger in the system of FIG. 1.

FIG. 3 is a partially broken away view of a shell and tube heat exchanger arranged for use as the heat recovery heat exchanger in the system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element; or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard as available a variation of 20 percent would fall within the meaning of these terms unless otherwise stated.

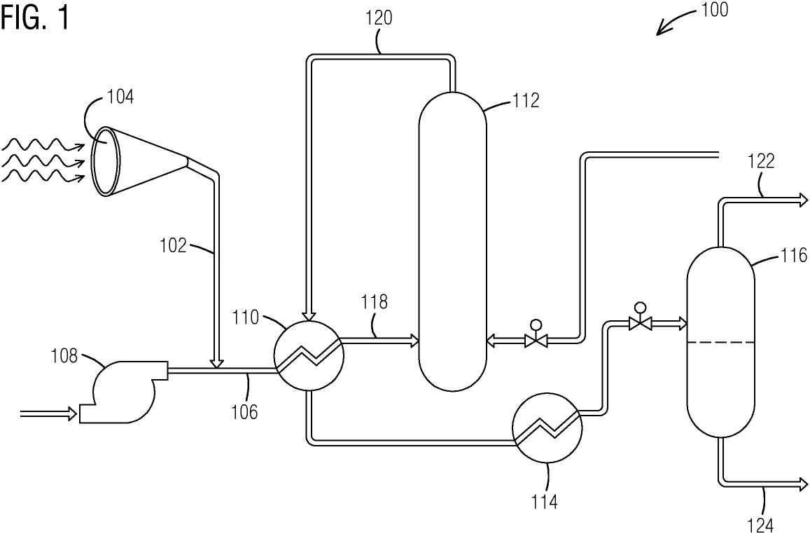

FIG. 1 illustrates a wet air oxidation system 100 suitable for use in oxidizing a process fluid including process fluids that contain sulfides and oxygen. The illustrated wet air oxidation system 100 includes a compressor 104, a pump 108, a heat exchanger 110, a reactor 112, a cooler 114, and a separator 116. The compressor 104, if employed is operable to provide an air supply 102 to a two-phase process fluid 106. The air supply 102 can be provided to augment the amount of oxygen in the two-phase process fluid 106. The pump 108 is employed to direct at least a liquid portion of the two-phase process fluid 106 to the heat exchanger 110.

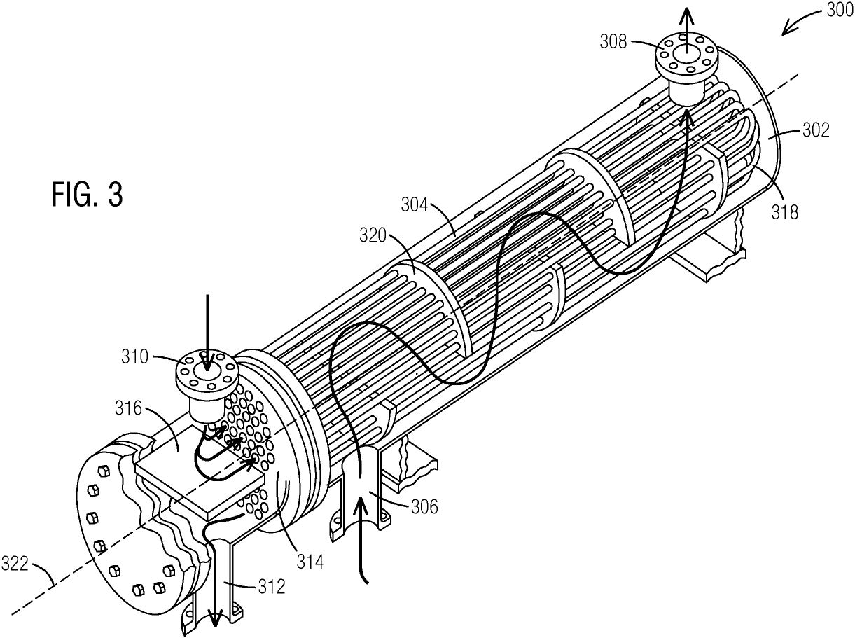

The heat exchanger 110 receives the two-phase process fluid 106 and a hot oxidized fluid 120 and uses the excess heat from the hot oxidized fluid 120 to heat the two-phase process fluid 106 to produce a preheated two-phase process fluid 118. The heat exchanger 110 will be discussed in greater detail with regard to FIG. 3.

The preheated two-phase process fluid 118 exits the heat exchanger 110 and enters the reactor 112. The reactor 112 is a vessel arranged to contain the preheated two-phase process fluid 118 and any other compounds or elements added thereto and to react those components to oxidize at least a portion of the preheated two-phase process fluid 118. In one example, the preheated two-phase process fluid 118 contains reactive sulfides and oxygen. The reactive sulfides are contained in a liquid portion of the preheated two-phase process fluid 118 and the oxygen is contained in both the liquid portion as well as a gas portion of the preheated two-phase process fluid 118. The preheated two-phase process fluid 118 within the reactor 112 will at least partially oxidize such that the sulfides will be eliminated and oxidized to sulfate. These reactions are exothermic such that the preheated two-phase process fluid 118 is further heated in the reactor 112 before it is discharged as a hot oxidized fluid 120.

The hot oxidized fluid 120 passes through the heat exchanger 110 to heat the two-phase process fluid 106 and produce the preheated two-phase process fluid 118. This process cools the hot oxidized fluid 120 which can then be discharged to an optional process cooler 114 for further cooling and then to a separator 116 where the hot oxidized fluid 120 (now cooled significantly) is separated into an off-gas 122 and a treated effluent 124 that are discharged from the separator 116.

In a wet air oxidation system 100 that treats high pH solutions, some of the components are made using nickel-based alloys. However, under certain conditions, these alloys are subject to corrosion. This can occur if the liquid portion of the two-phase process fluid 106 is separated from the gas portion, thereby allowing the oxygen within the liquid to be fully consumed and not replenished. Under these conditions, a very aggressive type of corrosion, referred to as sulfidation attack can take place. During sulfidation attack, nickel sulfide is formed on the surface of the metal. Unlike other oxide layers for other metals, nickel sulfide is not protective of the material underneath such that this type of corrosion can cause very aggressive failure of equipment.

To avoid this, the wet air oxidation system 100 is designed to assure adequate distribution and mixing of gas and liquid phases of the two-phase process fluid 106 in the wet air oxidation system 100.

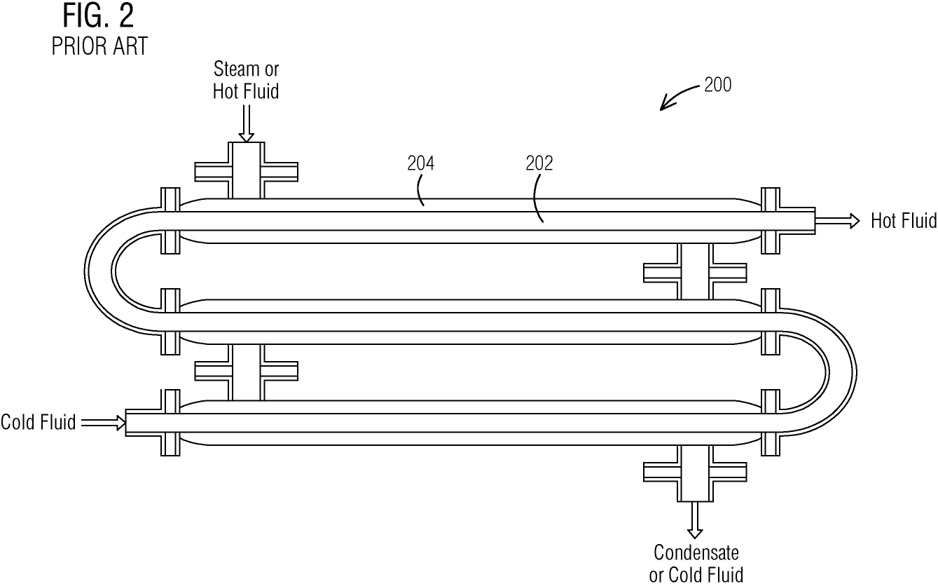

FIG. 2 illustrates a prior art heat exchanger in the form of a pipe-in-pipe heat exchanger 200 that has been used as the heat exchanger 110 in wet air oxidation systems 100 in which corrosion was a concern due to a lack of mixing. In pipe-in-pipe heat exchangers 200, all the liquid and gas flow through one pipe ensuring that there is good mixing and distribution. Specifically, one fluid flows through an inner pipe 202 and the second fluid flows through an outer pipe 204 that surrounds at least a portion of the inner pipe 202. While this arrangement assures consistent mixing of the two-phase process fluid 106, the efficiency of this type of heat exchanger is lower than desired due to the lack of heat transfer surface area when compared to other types of heat exchangers. In addition, pipe-in-pipe heat exchangers 200 are generally expensive when compared to more conventional heat exchangers and there are fewer manufactures of these types of heat exchangers.

FIG. 3 illustrates a shell and tube heat exchanger 300 that is suitable for use as the heat exchanger 110 in the wet air oxidation system 100 of FIG. 1. This type of heat exchanger is often referred to as a TEMA (Tubular Exchangers Manufacturing Association) style heat exchanger.

The shell and tube heat exchanger 300 includes a shell 302 that surrounds a plurality of tubes 304 to define two separate flow paths for two fluids. The plurality of tubes 304 extend in a direction that defines a long axis 322 for the shell and tube heat exchanger 300. In prior uses, TEMA style heat exchangers such as the shell and tube heat exchanger 300 were arranged with the long axis 322 positioned horizontally and with the hotter of the two fluids flowing through the shell 302 and the cooler fluid (i.e., the fluid being heated) flowing through the plurality of tubes 304. Thus, in the wet air oxidation system 100 of FIG. 1, the two-phase process fluid 106 would flow through the plurality of tubes 304 to provide the most surface area for efficient heat transfer to the two-phase process fluid 106 for preheating. However, it is possible that the gas and liquid may not equally distribute in the plurality of tubes 304 and there would be the potential for example to have a tube filled completely with liquid such that that tube does not have sufficient oxygen which in turn allows sulfides to quickly consume the oxygen in the liquid phase. This situation would create a localized reducing environment within that tube and may allow undesirable corrosion to take place.

To address this potential corrosion, the flows within the TEMA style shell and tube heat exchanger 300 are reversed from the more efficient and well-known arrangement. Specifically, the shell and tube heat exchanger 300 of FIG. 3 provides a two-phase process fluid inlet 306 near a first end of the shell and tube heat exchanger 300 to provide for the admission of the two-phase process fluid 106 into the shell 302 of the shell and tube heat exchanger 300 rather than into the plurality of tubes 304 as would be conventional. A preheated two-phase process fluid outlet 308 is provided at an opposite end of the shell and tube heat exchanger 300 to provide for the discharge of the now preheated two-phase process fluid 118 to the reactor 112. A hot fluid inlet 310 is provided to admit hot oxidized fluid 120 into the plurality of tubes 304 and a hot fluid outlet 312 allows for the discharge of the hot oxidized fluid 120 to the cooler 114 or to another component within the wet air oxidation system 100.

The illustrated shell and tube heat exchanger 300 includes a tube sheet 314 positioned adjacent one end of the shell and tube heat exchanger 300. The tube sheet 314 includes a plurality of openings that each lead to one of the tubes of the plurality of tubes 304. A partition 316 divides the tube sheet 314 into a first half and a second half with the first half fluidly connected to the hot fluid inlet 310 and the second half fluidly connected to the hot fluid outlet 312. Each tube of the plurality of tubes 304 extends from an opening in the first half of the tube sheet 314 in a direction that is parallel to the long axis 322 to a tube loop portion 318 where each of the tubes of the plurality of tubes 304 is bent 180 degrees. The tubes extend back to the tube sheet 314 and connect to a second opening in the second half of the tube sheet 314.

The shell 302 includes one or more baffles 320 that redirect the flow of the hot oxidized fluid 120 within the shell 302 in a serpentine fashion to improve contact with each of the tubes of the plurality of tubes 304. In the illustrated construction, each baffle 320 is a semicircular plate positioned alternately in the first half of the shell 302 or an opposite second half of the shell 302. Of course, other arrangements of tubes and baffles are possible depending on the particular application.

Because the flows are reversed from the conventional approach, the shell and tube heat exchanger 300 sacrifices efficiency, however, the two-phase process fluid 106 is better mixed and distributed within the shell 302.

To further enhance the mixing and to further reduce the likelihood of undesirable corrosion, the shell and tube heat exchanger 300 is preferably arranged such that the long axis 322 is not horizontal and more preferably such that the long axis 322 is vertical.

It should be noted that the various inlets and outlets of the shell and tube heat exchanger 300 could be reversed or repositioned from that shown in FIG. 3. For example, the two-phase process fluid inlet 306 could be positioned adjacent the tube loop portion 318 and the preheated two-phase process fluid outlet 308 could be positioned where the two-phase process fluid inlet 306 is illustrated if desired. Virtually any TEMA style heat exchanger could be employed as the heat exchanger 110 in the wet air oxidation system 100 of FIG. 1 so long as the two-phase process fluid 106 flows through the shell 302 rather than the plurality of tubes 304 as would be more conventional. In addition, it would be desirable to arrange the heat exchanger in a vertical or at least a non-horizontal direction.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A wet air oxidation system comprising:
a reactor including an inlet and an outlet, the reactor operable to oxidize a portion of a two-phase process fluid and to discharge a hot oxidized fluid from the outlet; and
a heat exchanger including a plurality of tubes that extend along a long axis of the heat exchanger and cooperate to define a hot fluid inlet coupled to the outlet to receive the hot oxidized fluid and a hot fluid outlet, a shell that surrounds the plurality of tubes and defines a process fluid inlet arranged to receive the two-phase process fluid, and a process fluid outlet arranged to discharge a preheated two-phase process fluid to the inlet of the reactor, wherein the long axis of the heat exchanger is arranged in a non-horizontal direction.

2. The wet air oxidation system of claim 1, wherein the long axis of the heat exchanger is arranged in a vertical direction.

3. The wet air oxidation system of claim 1, wherein the two-phase process fluid includes a liquid that contains reactive sulfides and a gas that contains oxygen.

4. The wet air oxidation system of claim 1, wherein the oxidation process within the reactor is exothermic such that a temperature of the two-phase process fluid at the inlet is lower than a temperature of the two-phase process fluid at the outlet.

5. The wet air oxidation system of claim 1, further comprising an air compressor operable to provide a flow of compressed air to a flow of process fluid to produce the two-phase process fluid.

6. A method of operating a wet air oxidation system, the method comprising:
orienting a long axis of a shell and tube heat exchanger in a non-horizontal direction;
directing a cool two-phase process fluid to an inlet of a shell of the shell and tube heat exchanger;
receiving a hot oxidized fluid in a plurality of tubes of the shell and tube heat exchanger;
heating the two-phase process fluid with the hot oxidized fluid to produce a preheated two-phase process fluid;
directing the preheated two-phase process fluid to a reactor; and
at least partially oxidizing the preheated two-phase process fluid to produce the hot oxidized fluid; and
discharging the hot oxidized fluid from the reactor.

7. The method of claim 6, wherein the long axis of the shell and tube heat exchanger is arranged in a vertical direction.

8. The method of claim 6, wherein the two-phase process fluid includes a liquid that contains reactive sulfides and a gas that contains oxygen.

9. The wet air oxidation system of claim 6, wherein the oxidizing step within the reactor is exothermic such that a temperature of the two-phase process fluid at the inlet is lower than a temperature of the two-phase process fluid at the outlet.

10. The wet air oxidation system of claim 6, further comprising operating an air compressor to provide a flow of compressed air to a flow of process fluid to produce the two-phase process fluid.

11. A wet air oxidation system comprising:
a reactor including an inlet and an outlet, the reactor operable to oxidize a portion of a pre-heated two-phase process fluid and to discharge a hot oxidized fluid from the outlet;
an air compressor operable to provide a flow of compressed air to a process fluid to define a two-phase process fluid;
a separator operable to receive a flow of cooled oxidized fluid and operable to separate the cooled oxidized fluid into an off-gas and a treated effluent; and
a heat exchanger including a plurality of tubes that extend in a direction that is parallel to a long axis of the heat exchanger and a shell that surrounds a portion of the tubes, each of the plurality of tubes includes an inlet positioned to receive a portion of the hot oxidized fluid and an outlet arranged to discharge a portion of the cooled oxidized fluid, the shell including an inlet arranged to receive the two-phase process fluid and an outlet arranged to discharge the pre-heated two-phase process fluid, the heat exchanger operable to preheat the two-phase process fluid contained within the shell using the hot oxidized fluid entering the plurality of tubes.

12. The wet air oxidation system of claim 11, wherein the long axis of the heat exchanger is oriented in a non-horizontal position.

13. The wet air oxidation system of claim 11, wherein the long axis of the heat exchanger is oriented in a vertical position.

14. The wet air oxidation system of claim 11, wherein the two-phase process fluid includes a liquid that contains reactive sulfides and a gas that contains oxygen.

15. The wet air oxidation system of claim 11, wherein the oxidation process within the reactor is exothermic such that a temperature of the two-phase process fluid at the inlet is lower than a temperature of the two-phase process fluid at the outlet.
